(19) United States
(12) Patent Application Publication
(10) Pub. No.: US 2016/0307277 A1
(43) Pub. Date: Oct. 20, 2016

(54) COLLABORATIVE STATISTICAL SPECIFICATION PAGES

(71) Applicant: Uriel Dario WENGROWER, Buenos Aires (AR)

(72) Inventor: Uriel Dario WENGROWER, Buenos Aires (AR)

(21) Appl. No.: 14/688,378

(22) Filed: Apr. 16, 2015

(51) Int. Cl. G06Q 50/00; G06F 17/30

(52) U.S. Cl. CPC G06Q 50/01; G06F 17/3089

(57) ABSTRACT

A system and method for statistically creating and managing general profiles, is provided in the present invention. The system comprising a plurality of communication devices connected to the internet and one or more computing systems implementing an application server. The method comprising an application server collecting particular profiles of at least one title and one attribute and or value and or associated content created by user accounts on communication devices; Analysing and identifying attributes and values of the profiles and their contents; Statistically creating and updating a general profile based on the received attributes, values and their associated contents, linking back to the related user particular profiles. Contents comprise one or more assets from one or more asset types; asset types include audio, video, images, text and other media files.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE OR A COMPUTER PROGRAM LISTING COMPACT DISC APPENDIX

Not Applicable.

### BACKGROUND OF THE INVENTION

Traditional offers for products, services, experiences, etc. are briefly profiled into specification lists. These are built from several listed describing parameters (“attributes”) and the description of each of the latter (“values”). However, these lists do not include all the same attributes different people appreciate or are interested in. Moreover, these lists are not dynamic and only include first hand, one-time content, regardless of new reviews, content or contributions other than those of the publisher.

Additionally, these specification lists do not include any of the alternative uses for the described products, services, experiences, etc. that may come up later upon usage and or review, nor customizations and or change proposals for the stock offer.

Moreover, these specification lists do not allow for creation of new lists based on other, previous existing lists, to reflect descripting attributes of a collective offer, sentiment or preference through data mining.

On the other hand, microblogging and blogging services let users upload content as individual posts in a regular chronological order. Furthermore, some services let users label (or “tag”) these posts to create links between theirs and those posts of other users with equal tags; thus, creating a collaborative user input group of posts that pile up in chronological order. However, the latter results in crowded lists of posts with no regard for their contents in terms of repetition or addition from one post to another, thereby, limiting the presentation of unmined data from collaborative efforts.

### BRIEF SUMMARY OF THE PRIOR ART

US patent publication 2013/24757 (Doll & Weskamp) teaches building up and laying out of dynamic news pages with user-generated contents provided from a variety of sources. The size-range of the contents are evaluated to determine a score representing suitability for placement in page slots of a predermined template and the one with the best score is selected.

U.S. Pat. No. 8,612,136 (Levine et al) discloses a method and attendant system which dynamically monitor a large quantity of vehicle navigation devices which are statistically analysed for progressively building (developing) road maps including pathway attributes and associated values such as one- or two-ways, tunnels, roundabaouts, road-surface conditions, etc. No specific algorithms are given for the statistical analysis.

Other publications disclose use of statistical analysis to develop values related to specific attirbute. EP patent 1,518,405 (Philips) groups user-profiles according to Vornoi cluster techniques. There is no suggestion heretofore for creating and dynamically maintaining specification lists with collaborations randomly inputted by multiple users or subscribers on the basis of multiple attributes and dynamically sorting and organising collaborative specification lists through statistical analysis of user values, whether objective or subjective associated with the attributes. U.S. Pat. No. 8,401,009 (Dorsey & Stone) discloses formation of user-follower groups for receiving broadcasted messages in different devices which are transparent to the source.

### BRIEF SUMMARY OF THE INVENTION

A general object of the invention is to combine the advantages of specification lists and blogging systems.

A further object of the invention is to provide viewable specification material, designated hereinafter “collaborative specification pages”, comprising assets randomly input by several users over different points in time, wherein the assets are associated with specific names (titles) and the pages are dynamically updated by grouping new user content by carrying out statistical analysis on assets within a same name for presentation and reviewal by subsequent users browsing the collaborative specification pages.

According to the present invention, a method and attendant system configured for creating and managing collaborative statistical dynamic specification pages is provided. An application server is configured to receive inputs from several users, the inputs comprising specification lists consisting of names (titles) and corresponding assets which may be statistically analysable. Defined herein are
Specification list: a specification page or profile contributed by a user for linking with others into a collaborative specification page. (Although actually a page, “list” is used hereinafter for users to facilitate reader differentiation from the collaborative page).
Titles (names): topics pertaining to the subject of the assets, such as of an event (a conference, inauguration, race, meeting, etc., e.g. “Buenos Aires marathon”), a product (books, lawn-mowers, racing bikes, herbicides, etc.), a person (sportsman, artist, actor, politician, etc.), etc.
Attributes: parameters to which values are associated, such as price, distance, time, colour, etc.
Values: scalable data, generally numeric (“$50”, “3h30m”), includes colours (“red”) and ratings or discrete qualities (“good”, “regular”, “bad”, “expensive”, etc., including types of values exemplified in the specification hereinafter.
Value type: formats for expressing values, e.g. “50 mph” (numeric type) or “fast” (string type).
Contents: user-generated media information which may be of different types like text, images, audio, video, etc.
Assets: a general term for attributes, values or contents.
Entry line: a combination of assets.

More particularly, according to the present invention:
(a) An application server stores specification pages provided with titles and attributes with formatted values and associated contents. Initial lists (pages) may be uploaded by users.
(b) Users browse specification pages using communication devices and may upload specification lists containing name-assosciated assets (attributes, values or contents). The server converts the assets into provided, predetermined formats. (
c) The server receives the plurality of user-uploaded lists, identifies attributes therein and analyses their associated values and associated contents applying predetermined statistical algorithms to link and combine each received specification list with others into one or more dynamic pages according to matching titles of the specification lists and analysis of their attributes and values. The uploaded assets may add to a collaborative specification page or create or update a list.
(d) Attributes of the collaborative page are dynamically updated with the statistically most relevant values for each statistically relevant identified value type, according to statistical analysis of the values of each attribute of the linked specification lists.
(e) Deviation limits from relevant values are dynamically updated within the dynamic page, according to statistical analysis and type, in order to group the corresponding contents from linked specification lists.

### BRIEF DESCRIPTION OF THE VIEWS OF THE DRAWINGS

The subject matter regarded as the invention is particularly pointed out and distinctly claimed in the concluding portion of the specification. The invention, however, both as to organization and method of operation, together with objects, features and advantages thereof, may be best understood by reference to the following drawings in which:

FIG. 1 is a high-level block diagram of a system for creation of collaborative specification pages according to some embodiments of the present invention; and

FIG. 2a shows a screenshot of a Smart-Phone GUI of a collaborative specification page designed according to an embodiment of the present invention. FIG. 2b shows a different screenshot of the same collaborative specification page of FIG. 2a after browsing such as by a user.

FIGS. 3a and 3b show two specification lists (as displayed on a Smart-Phone GUI for example) uploaded by two different users and which have been linked to the collaborative specification page displayed in FIGS. 2a and 2b.

FIG. 3c illustrates how multiple user specification lists are linked into the collaborative specification page displayed in FIGS. 2a and 2b and provide the content for browsing within the latter.

FIG. 4 is a flow chart illustrating a method for creation and management of collaborative specification pages according to the present invention;

FIGS. 5a-5e are schematics illustrating data input interfaces according to embodiments of the present invention;

FIGS. 6a-6g illustrate several combinations of attributes, values or contents (“entry lines”) according to embodiments of the present invention;

FIG. 7 is a schematic illustrating an example of how some specification lists may be linked into building a collaborative specification page according to embodiments of the present invention;

FIG. 8 illustrates an exemplary interface of a collaborative specification page for a user to engage with according to some embodiments of the present invention; and

FIGS. 9a-9f are schematics illustrating application examples for collaborative specification pages, according to embodiments of the present invention.

One skilled in the art will readily recognize from the following discussion that alternative embodiments of the structures and methods illustrated herein may be employed without departing from the principles of the invention described herein.

In all the figures, like reference numbers identify like parts.

### DETAILED DESCRIPTION OF A PREFERRED EMBODIMENT

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

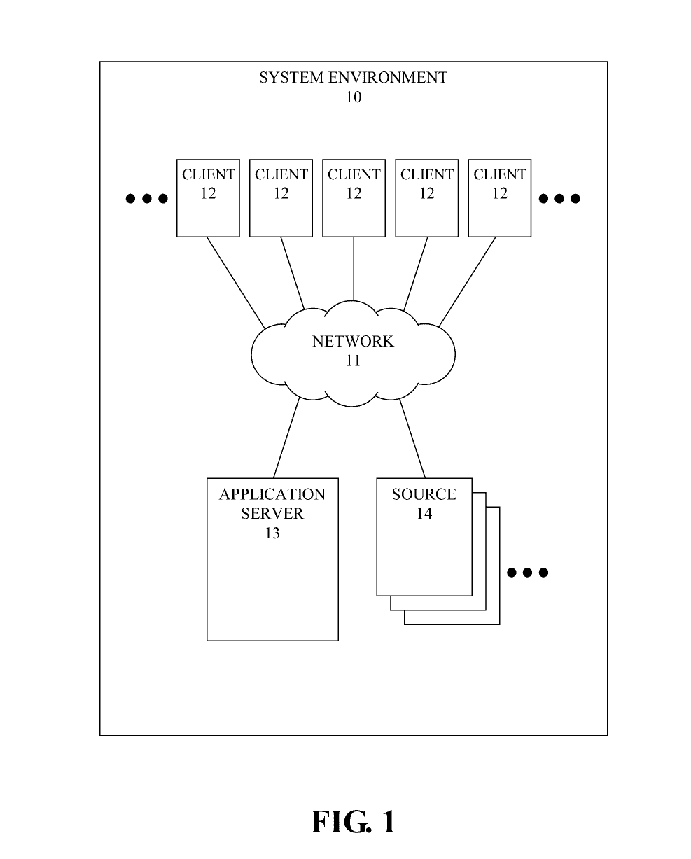

FIG. 1 is a high-level block diagram of a system 10 for creation of collaborative specification pages according to some embodiments of the present invention. The system 10 may include a plurality of communication devices hosting a client 12, a plurality of sources 14, and an application server 13, connected via a network 11, such as the Internet.

The plurality of communication devices hosting a client 12 can be any computing device provided with a browser, for accessing web pages, or an application (commonly known as “App”) or dedicated software, for accessing server content, and may provide a display for viewing them (and or a speaker for hearing them). Communication devices 12 may include a touch screen and or keyboard and or a microphone and or a camera in order to input content as well. Communication devices hosting a client 12 may be, for example, mobile phones, tablet phones, tablet computers, personal computers, mobile computers or any other capable user interface device. Additionaly, devices may also include communication input-only devices, for example, drones, health trackers, sensors and any other device hosting a client connected to a network such as the internet (known as Internet Of Things or IOT devices). While a limited number of clients 12 (devices hosting a client) are shown in FIG. 1, in practice there may be thousands or millions of clients 12 in communication with the system 10.

The plurality of sources 14 can be, for example, any hypertext link to or any form of text, image, audio or video on web pages, web feeds, blogs, social networks or other distribution platforms. Indeed, any device input or upload to application server 13 such as text, image, audio or video or any other computer file that of any form of user generated content uploaded from communication devices hosting a client 12 may be used for the same purpose described herein. For convenience, content from these sources 14 or device inputs or uploads, will be referred to as “content”, regardless of consisting of one or more of the same or a mix of the above described types.

The connection between communication devices hosting a client 12, the plurality of sources 14 and application server 13 may be established by any known connection protocol, for example, Transmission Control Protocol (TCP), User Data Protocol (UDP), Hypertext Transfer Protocol (HTTP), Wireless Application Protocol (WAP) or any other suitable protocol. These protocols may be run through a communications network 11. The connection between communication devices hosting a client 12 and application server 13 may be, for example, by fixed line phone network, DSL network, cable network, fiber optics network connection or any other fixed communication means. Moreover, connection may be mobile, for example, by cellular network or wireless network or any other mobile communication means.

Application server 13 may consist of a single computer, or a network of computers, including cloud-based computer implementations. The computers may be running a server configuration of an operating system, for example LINUX or any other suitable operating system. The computers may preferably be server class computers with one or more CPUs and or main memory and readable persistent storage memory, according to the needs of the operating system installed, its server configuration, data base running capabilities and network hosting program tasks. The operations of these systems as described herein can be controlled through either hardware or through computer programs installed in computer storage and executed by the processors of such servers to perform the functions described herein. These systems may include other hardware elements necessary for the operations described here, including network interfaces, networking devices (e.g., routers, firewalls) and protocols, input and output devices, which are not detailed so as not to obscure the relevant details of the system 10.

### [System: Tx]

Application server 13 may receive a titled list of information and or content from communication devices hosting a client 12 connected through communication network 11. Application server 13 may record an input timestamp for such information or content received for further statistical analysis. Additionally, devices hosting a client 12 may be equipped with GPS or cellular network location systems or any other means to provide application server 13 with their location while performing such communication for further statistical analysis.

### [System: Tx]

Additionally, users of communication devices 12 may use the input means on communication devices to rate or comment on information and or content on application server 13 and send messages to other users that they may later reach, within the system 10, through their devices.

### [System: Rx]

Application server 13 performs statistical analysis of received lists of assets in the specification lists that the users send (as described in more detail hereinafter) through the multiple communication devices 12. Based on the statistical analysis, application server 13 may identify priority such as novelty, interest and participation on the received information and or content. Based on these priorities, application server 13 may build a dynamic collaborative general page of information or content (“collaborative specification page”) of the same title as those particular lists of users. Therefore, user lists under the same list title received by application server 13 may be grouped or linked through these dynamic collaborative general pages. These dynamic lists may update in time, for example, whenever the statistical analysis on all particular user lists by the same title show a change in priority over novelty, interest and participation on any information and or content. Furthermore, application server 13 may use timestamps to deduce the information or content's novelty.

### [System: Rx]

Communication devices 12 may be used to browse a collaborative specification page through a display screen. Application server 13 may perform all tasks and requirements necessary to adjust the information and or content in the collaborative specification page to a proper layout in order to serve pages to be properly browsed through the plurality of devices 12. The collaborative specification page, by being linked to particular lists of users, may lead the user of communication devices 12 to browse particular lists of other users received by application server 13 as well. Communication devices 12 may also be provided with a speaker to output sound from text readings or audio or video content from any browsed list.

### [What]

Collaborative specification pages provide users with a simple list layout of information and content on a topic, that have been statistically analyzed, filtered, added, combined, selected and or put in order from a variety of information and or content from particular lists of users. Thereby, collaborative specification pages enable users to browse a richer and dynamically updated specification list on topics of interest (“topics”) such as biography, historical events, products, services, experiences, reviews, etc. Moreover, collaborative specification pages let users connect with each other through browsing, rating and commenting the information and or content contributions of user specification lists that link to the same topic, as well as statistically set the priority on general overall importance of information and or content in the process.

### [List]

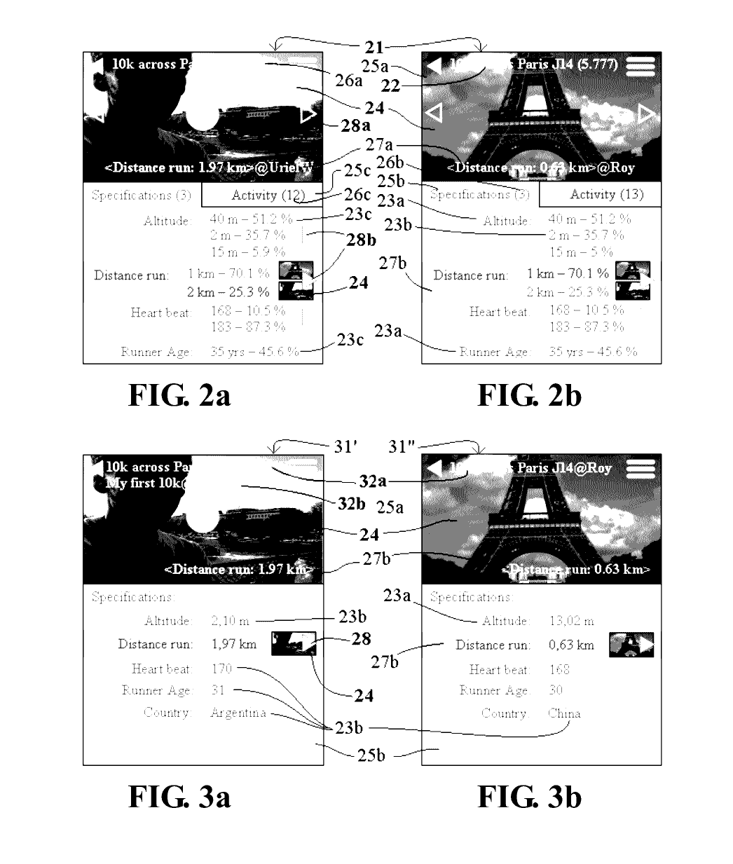

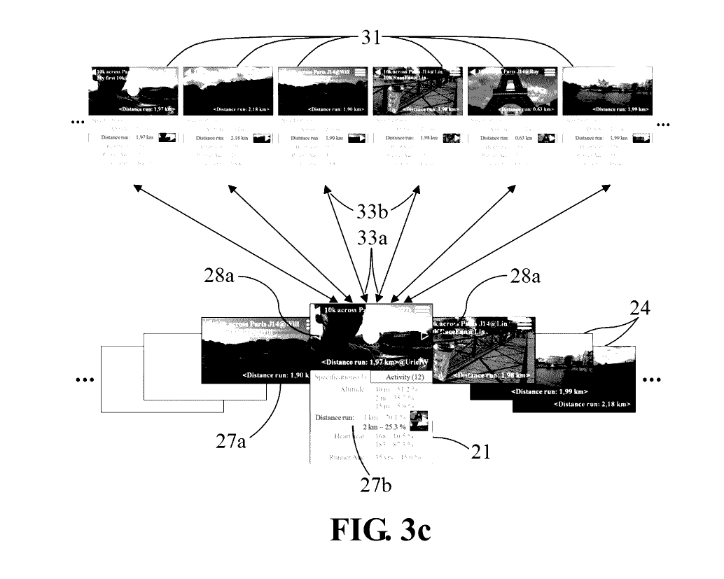

FIGS. 2a and 2b show two different screenshots of a same collaborative specification page 21 while browsing it, according to an embodiment of the present invention. FIGS. 3a and 3b show two different specification lists 31′-31″, input from different users, that link to the collaborative specification page 21. Collaborative specifications page 21 and specification lists 31′-31″ (collectively 31) each comprise a “title” 22 identifying a specific topic, a list of defining parameters (“attributes”) 23a and each of their corresponding defining descriptions (“values”) 23b which result into a brief description of a single topic, for example biography, historical events, places, products, services or experiences. In addition or in place of the values (descriptions) 23b, each specification page 21 or list 31 may include media “content” 24, such as text, image, audio or video content (in this example video content) for the corresponding value 23b. The content is displayed in an upper pane 25a of the screenshot and the attributes 23a with their corresponding values in a second pane 25b labeled “Specifications”. A third pane that may show a timeline for the latest updates of the collaborative specification page 21 may be brought forward over the “Specifications” pane 25b by clicking on its “Activity” label tab 25c. Numbers 26b and 26c within brackets indicate how many recently added attributes 23a and uploads, respectively, are displayed in the “Specifications” and “Activity” panes 25b and 25c.

In the collaborative specification pages 21, the title 22 is followed by a number 26a indicating how many user specification lists 31 link and combine to build the collaborative specification page 21 with that title 22; and attribute values 23b are followed by percentage weight 23c for the corresponding value 23b according to statistical analysis of all the user specification lists 31 that have linked together to build the collaborative specification page 21. In the specification lists 31, the “titles” 22 are followed by the user name in a field 32a having a title@username format, indicating that they are user specification lists 31. FIG. 3a further shows a case of a user list 31′ with a second name 32b.

In FIG. 2a, the attribute “Distance Run” and the value “2 km” have been highlighted by the user while browsing whereas FIG. 2b corresponds to a different user or the same user at a different time browsing with the arrows 28a or highlighting the attribute “Distance Run” and the value “1 km”. Therefore, the specification list 31′ in FIG. 3a contributes with contents 24 for the highlighted value “2 km”, while the specification list 31″ in FIG. 3b contributes with contents 24 for the highlighted value “1 km” for the attribute “Distance run” of the collaborative specification page 21. The page screenshot further includes a reference 27a (as <attribute: value>@username) to a currently highlighted selection 27b, for content 24, and browsing arrows 28b for getting into more detail.

FIG. 3c illustrates how user specification lists 31 build into a collaborative specification page 21 and provide the content 24 for browsing within the latter. The arrows 33a from the user specification lists 31 to the collaborative specification page 21 indicate those combine into it. The arrows 33b from the collaborative specification page 21 to the user specification lists 31 show how the first 21 links to the latter.

Topics of different categories, for example a product and a historical event, may vary more in their attributes regardless of the value of each attribute. Topics of the same category, for example two products, may vary less in their attributes (may share several attributes) but more in the values associated with each of the latter. Two specification lists let users compare topics on their similarities, when attributes are found on both lists, and also on the differences, when one attribute is found on only one of the lists and not on the other. For example, two different cars may offer different wheel size and different tires; both share similar attributes but have different values. But, one of the cars may have electronic stability control (ESP) incorporated and the other may not; the extra attribute of having ESP marks a difference.

### [Content Layout]

The value of each attribute 23a may express a defining characteristic of the topic specified on the list; by associating to each of the attributes 23a, for example text, image, audio, video or any other computer file in any form of user generated content (“content”), their value 23b can be enriched or supported in exemplary, explanatory, educative and informative depth. As FIGS. 2a and 2b illustrate, collaborative specification pages 21, in accordance with an embodiment, provide a convenient layout for content 24 alongside the attributes 23a and values 23b of the specification lists for users to browse through within their devices hosting a client 12. This layout may be defined either by pre-stored information in application server 13, by user preferences or by an automatic algorithm through statistical information of user browsing pages, in accordance with an embodiment. Pre-stored information on layouts of collaborative general specification pages 21 may be used to best fit the list of attributes 23a, their value 23b and their associated content 24 throughout the plurality of devices hosting a client 12. As each device may have different screen size and resolution, pre-stored information on layouts from the system 10 may be used by Application server 13 to adapt pages 21 for each device; the user may select from the available template setups a different layout (e.g. bigger fonts for attributes and values or bigger contents); an automatic algorithm on the application server 13 may request the screen size and resolution from plurality of devices hosting a client 12 and adapt page layout accordingly; and application server 13 may statistically record user preference for content 24, attributes 23a or values 23b and adapt page layout accordingly. For example, in an embodiment, if one user usually tends to browse image content 24 immediately within the first seconds of page display on his device 12, application server 13 may set to show bigger pictures for this user the next time a page 21 is served to his device 12 while trimming text information shorter.

### [Method Intro]

Collaborative specification pages 21 combine the sum of user specification lists, user rates and comment inputs through statistical analysis by the application server 13, in accordance with an embodiment. User listed attributes 23a, their values 23b and their content 24 contributions are analyzed, filtered, added, combined, selected or sorted by the application server 13 thereby creating linking collaborative specification pages 21.

### [Method]

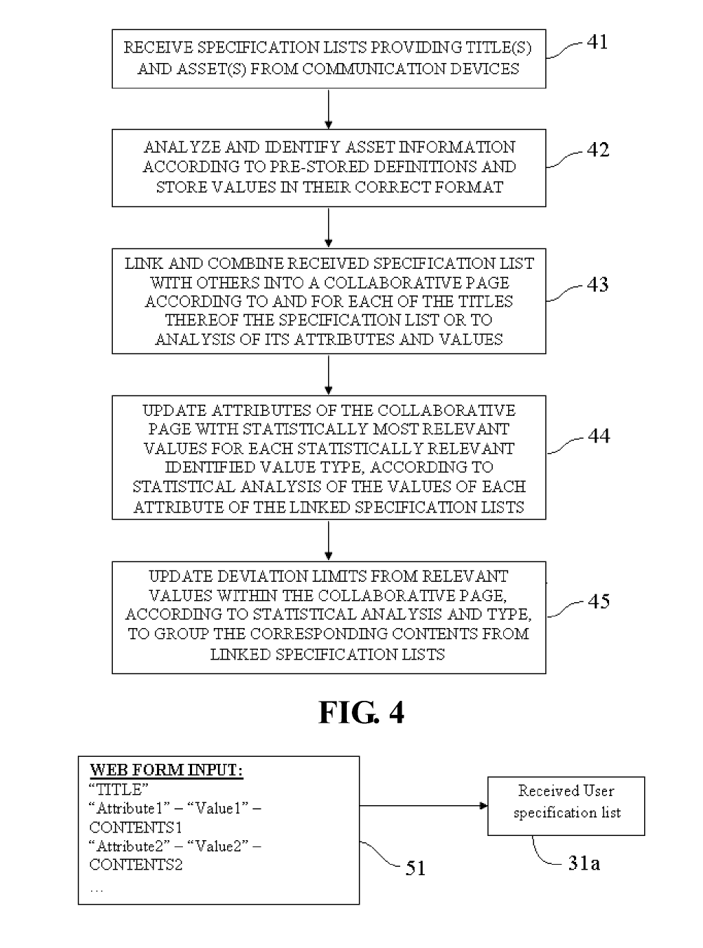

FIG. 4 is a flow chart illustrating a method for creation of collaborative specification pages 21 according to an embodiment of the present invention. This method may be implemented, for example, by application server 13 as illustrated in FIG. 1. As shown in block 41, the method may include, for example, receiving, by application server 13, a plurality of specification lists providing at least one title and one attribute and or value and or content, from a plurality of communication devices 12. As shown in block 42, the method may include, for example, analyzing and identifying, for example, by application server 13, attributes and or values and or associated content information according to pre-stored definitions to store values in the correct format. As shown in block 43, the method may include, for example, linking and combining, for example, by application server 13, the received specification list with others into one statistically created dynamic general specification list (“collaborative specification page”) according to and for each of the received titles of the specification list and the analysis of its attributes and values. As shown in block 44, the method may include, for example, updating, for example, by application server 13, attributes of the dynamic list with statistically most relevant values for each statistically relevant identified value type, according to statistical analysis of the values of each attribute of the linked specification lists. As shown in block 45, the method may include, for example, Updating, for example, by application server 13, deviation limits from relevant values within the dynamic list, according to statistical analysis and type, in order to group the corresponding contents from linked specification lists.

The method may be performed using a different sequence or combination of steps than illustrated here, and may be performed concurrently in multiple threads.

### [Method]

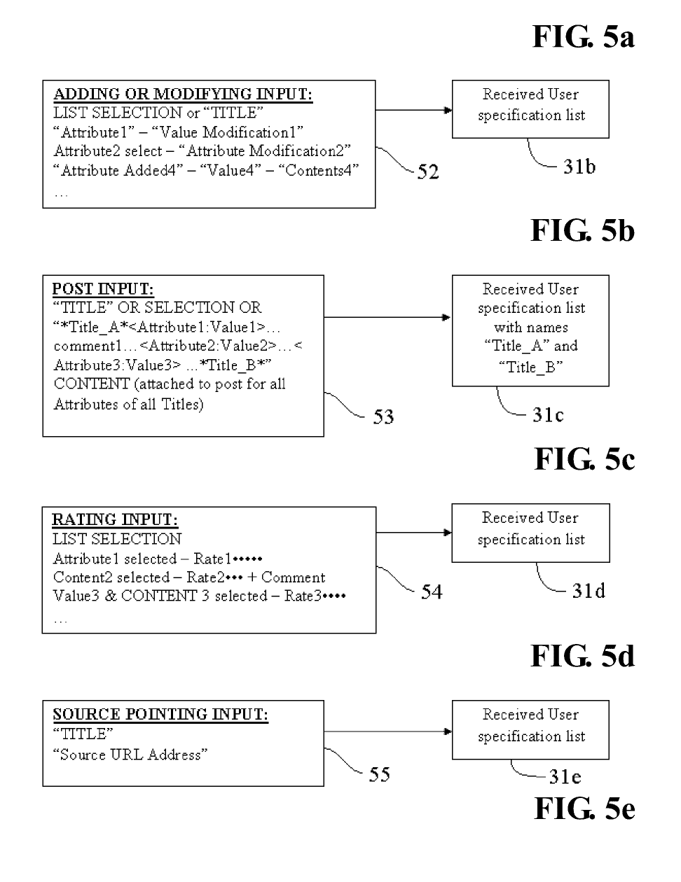

In this example, the application server 13 may receive 41 from the plurality of devices 12 a plurality of specification lists from users. FIGS. 5a-5e illustrate exemplary data input interfaces on devices 12 and the processing of application server 13 to implement step 41 of FIG. 4; other implementations may use different input interfaces to provide the same result.

FIGS. 5a-5e illustrate step 41 of the method showing examples of how user specification lists 31 can be received from user device hosting a client 12 through several input interface types 51-55. These interfaces 51-55 may vary in amount, type of information or content a user may need to input as a specification list. Application server 13 may receive 41 a user specification list input, for example, as a new list 31 of attributes 23a, their values 23b or their contents 24; as a modification or addition to an existing user specification list of the user; as a post; as a rating of a collaborative specification page 21 or a user specification list of another user or its attributes 23a, values 23b or content 24; or as a link to sources 14 addressed by the user to have the input necessary to build a specification list. Application server 13 may process each input interface data accordingly to build or update a specification list of a user.

As shown in input interface 51 in FIG. 5a, a specification list 31a may be provided by the user through input on each of the fields of a form with attributes 23a, values 23b or contents 24, within interface 51, with the proper information using his device 12.

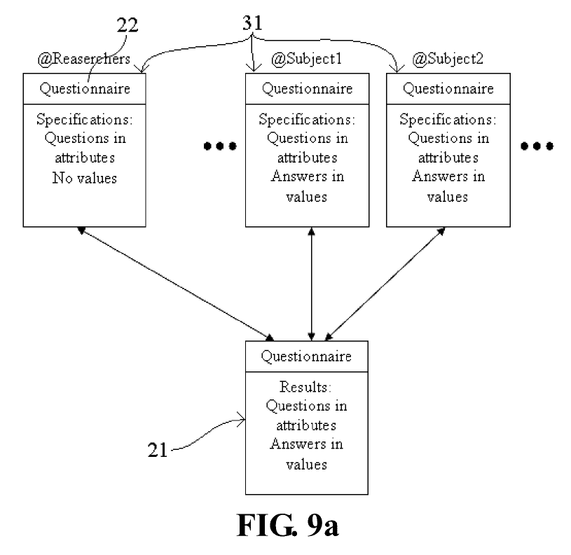

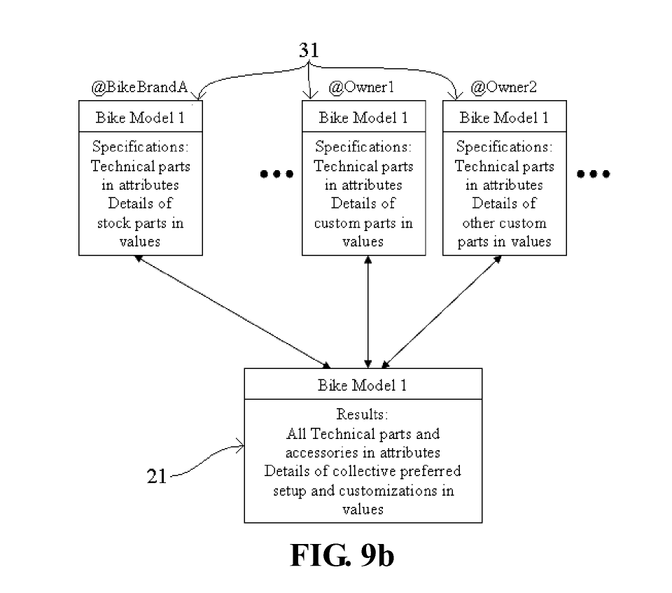

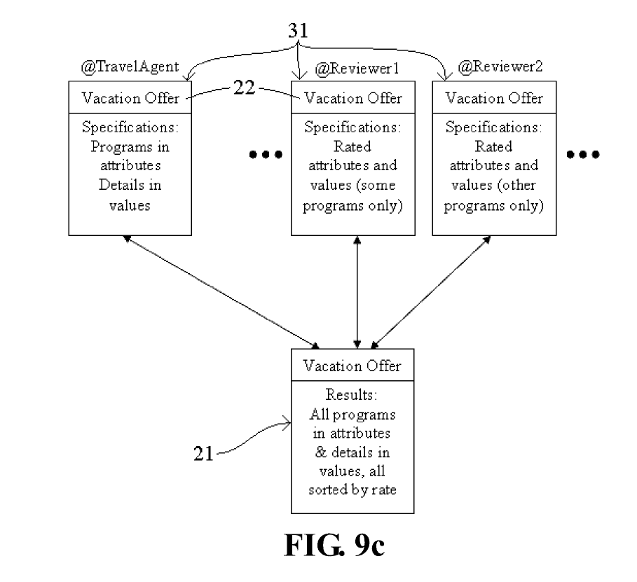

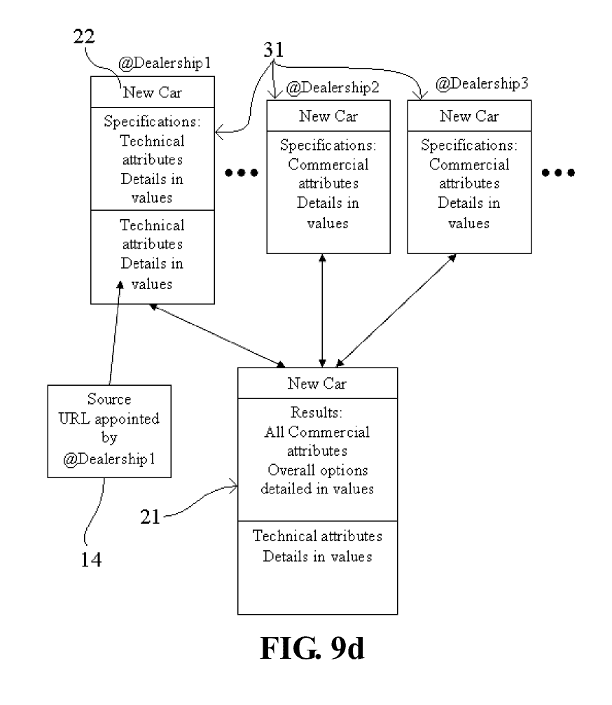

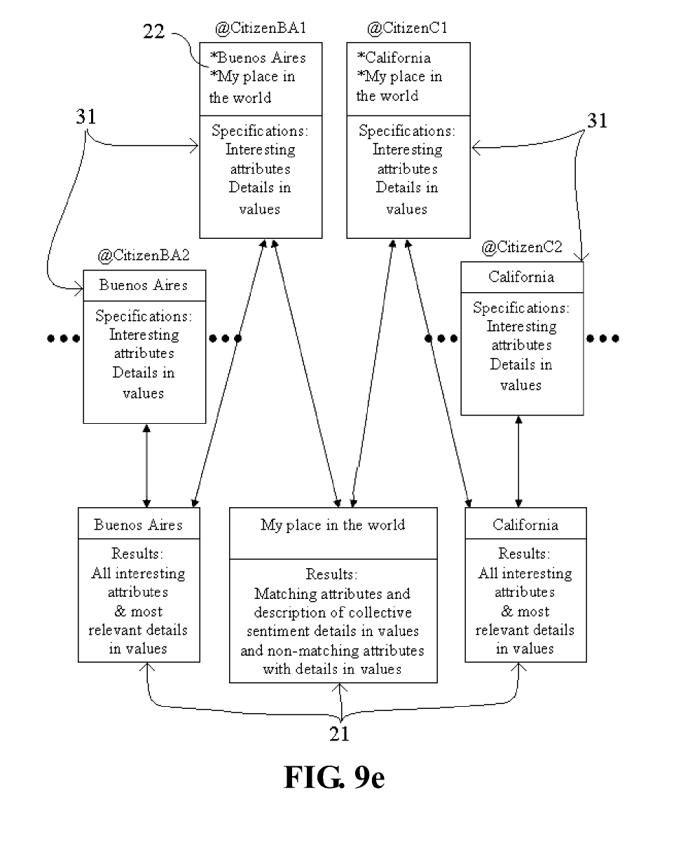

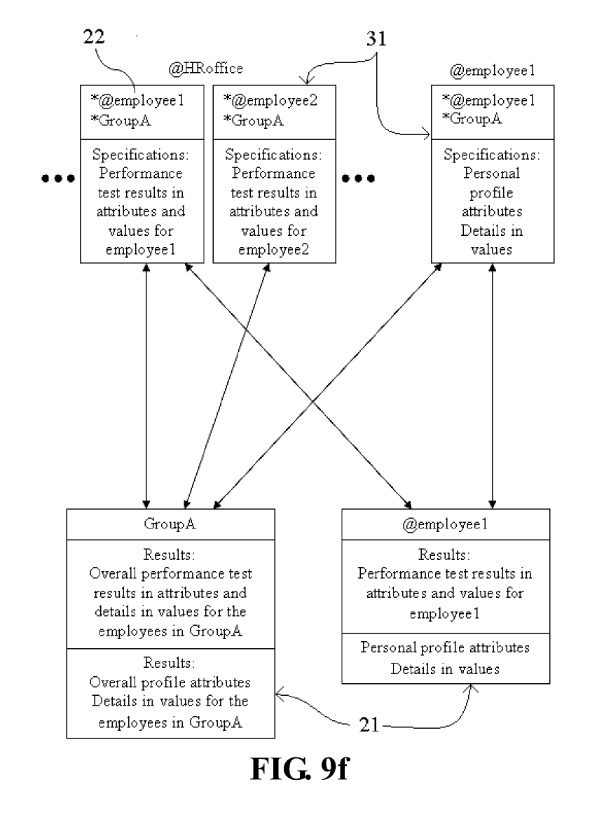

Content uploads may also be performed through selecting each from the device 12 or by input of a URL pointing its location from sources 14; by entering them in their respective fields within the form. For example, a group of researchers may propose a social questionnaire through a webform interface and ask other users to fill in this form within a specification list 31 of their own with the system 10 by the same title 22; results of the questionnaire will be processed by the system and shown within the collaborative specification page 21 by that title 22. A schematic for this application example is provided in FIG. 9a.

As shown in input interface 52 in FIG. 5b, a specification list 31b may be provided by the user through selecting an existing specification list of his account with the system 10; and either change and or add at least one attribute 23a, value 23b or content 24 of the selected user specification list.

### [API 3^{rd} Party]

Additionally, in some embodiments, the application server 13 may provide third-party application developers with application program interface (“API”) functions to send certain attributes 23a, values 23b or contents 24 automatically from devices 12 as well as functions to retrieve them from application server 13. For example, as shown in the page example of FIGS. 2a-2b, a third-party application on devices 12 may periodically send pre-selected attribute information, pictures and video from runners to application server 13, while activated during a short “10k” race. Application server 13 may then combine all data within a collaborative specification page for users to follow the race instant statistics on-line or review it after finishing. A commercial account for the race organizer may be needed for validating user input.

As shown in input interface 53 in FIG. 5c, a specification list 31c may be provided by the user through a single post by identifying one or more titles 22 of specification lists and one or more attributes 23a and their values 23b with respectively predefined escape characters (e.g. “<attribute: value>”; “*Title of the list*”; “*@username*”) within the message of said post. Furthermore, since a post consists of a single entry of text information and an associated content 24, the latter may be defined as the associated content for attributes 23a or values 23b of the specification lists 31 identified within the post. Therefore, for this example, a post with two specification titles 22, two attributes 23a, one information value 23b and an associated content 24 may modify or add the two attributes 23a with said information value 23b and associated content 24 on the specification lists 31, by those titles 22, of the user account with the system 10. If the user has only one list 31 by one of these titles 22, application server 13 may receive this post as to add the other title as a second title to the existing list. If the user has no lists by these titles 22, application server 13 may receive this as one list with two titles 22 to be created in his account. Additionally, these posts may come from sources 14 such as web feeds, blogs, social networks or other distribution platforms. For example, a company may have a particular specification page of a product, for example a racing bike, within their account with the system. Some attributes may determine different types of stock parts; another user may post (using his cellular phone) an image or video of his customized product showing the change for a custom performance part; by including the same title 22 and some attribute 23a, with the proper escape characters, within the message of said post, the collaborative specification page 21 (by that title) will show users the stock parts and the latter customization for review (as a collective preferred setup for the racing bike). A schematic for this application example is provided in FIG. 9b.

As shown in input interface 54 in FIG. 5d, a specification list 31d may be provided by the user through selecting either the collaborative specification page 21 or a specification list of the account of another user with the system 10 and rating at least one attribute 23a, value 23b or content 24 of the selected list. Then, the provided specification list may include the same title 22 and the same attributes 23a or values 23b and references to rated contents of the rated list of the first user, including the respective rate setup. For example, a user may like and rate a value for an attribute on the specification list for a vacation trip of a second user; a specification list by the same title will be created on the account with the system of the first user, including that value 23b and attribute 23a; the latter will increase the statistical weight of this value 23b for that attribute 23a of the collaborative specification page 21 (by that title 22) linking to both. A schematic for this application example is provided in FIG. 9c.

Furthermore, as a user rates any complete selected list 31, application server 13 may, for example, receive 41 a list 31 including the same name and the rating on a special attribute, named “rate”, serving this purpose. Application server 13 may use any of the mentioned rates for later statistical analysis.

As shown in input interface 55 in FIG. 5e, the specification list 31e may be provided by the user through reference to sources 14. For example, the user may input a title 22 and a web page through a specific URL; application server 13 may read the document object model (“DOM”) for the page and identify a list of combinations of attribute names 23a and values 23b, as well as associated contents 24 from it. Then, in this example, the provided specification list 31e may consist of a list including the same attributes 23a, values 23b and references to contents 24, in case of contents 24, that lay within the above mentioned web page. For example, a car brand may have their last new car published on their website; their official brand dealership may want to add this to his account with the system to show their audience they will be selling these units; the dealership may point out the corresponding URL to build a particular specification page 21 on this car on his account with the system; the dealership may later add particular attributes regarding the sale of this new unit such as delivery time, financial options, etc. to his particular specification page about the car; the collaborative specification page 21 (by the same title 22) may, thereby, indicate the technicals from the product website along with the different commercial options available for the car and thus connect users (interested in the car) with dealership through their interest in specific commercial values (e.g. the shortest delivery time dealership). A schematic for this application example is provided in FIG. 9d.

Additionally, sources 14 may opt to include a specifically programmed button to add their specification list to the account of a user with the system. This button triggers an API function in application server 13 implementing this last input interface automatically for the user pressing the button while logged into his account browsing sources 14. This button may be added as embedded code into sources 14 as web pages, web feeds, blogs, social networks or other distribution platforms.

[Additional] Additionally, application server 13 may, for example, receive 31 user locations, in case the devices 12 can provide geo-location, and save a timestamp including location for each named specification list received 31. Furthermore, application server 13 may use this information for statistical analysis and finally to let users browse collaborative specification pages to find specification lists of other users according to geographical location.

### [Method]

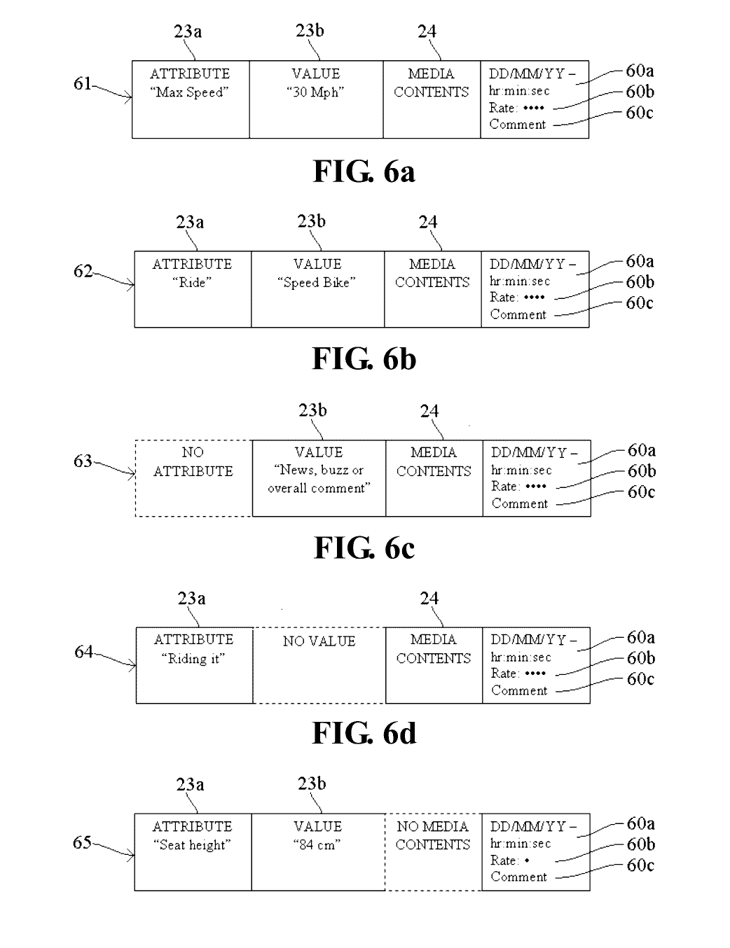

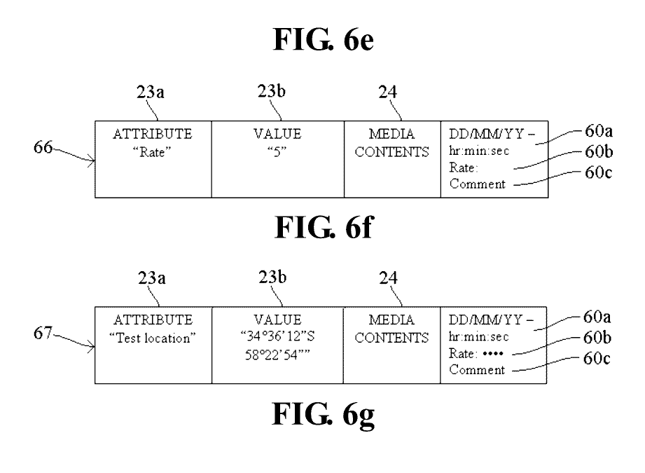

After receiving 41 a specification list 31 from a user, application server 13 may, for example, analyze and identify 42 attributes 23a, values 23b or associated content information 24 according to pre-stored definitions to store values in the correct format. FIGS. 6a-6g illustrates some examples of different entry lines according to some embodiments of the present invention.

Application server 13 may, for example, identify attributes 23a or values 23b including quantities, numbers, amounts of currencies, physics metrics (e.g. position, distance, speed, acceleration, weight, etc.), location (e.g. name of places, addresses, geo-coordinates, etc.), colors, contact information (e.g. e-mail addresses, telephone numbers, social network contact names and pages, URLs, etc.), step number (e.g. step1, step2, etc.), date and time, duration, bar codes (e.g. EAN13), relative rates (e.g. %), text names (e.g. single word, single string or single line text), text description (e.g. multiple line text), frequently asked questions (e.g. FAQ) and list ratings (e.g. topic or title rate by a user).

Additionally, in one embodiment, a system administrator may load new definitions for other different type of values into application server 13 that may later come up without departing from the principles and scope of the invention.

As detailed in examples shown in FIGS. 6a-6g, specification lists may consist of at least one title 22 and one attribute 23a, value 23b and or associated content 24. Moreover, a combination of any of the latter three may be considered a single line of a specification list (“entry line”). In an embodiment, a brief description or comment about associated contents 24 and an individual rating for each entry line may also be provided as part of the entry line and the latter may be used, for example, by application server 13 for statistical analysis and search purposes.

Application server 13 may, for example, analyze and identify 42 each entry line.

First, for example, by comparing pre-stored definitions with the name of the attribute; and or with the information within the associated content (this may include file name, description or comments and other information). Next, information within the value may be analyzed, for example, by application server 13. Each analysis may be performed, respectively, on each part of the entry line according to the parts provided within. After recognizing words, numbers and or acronyms and patterns between them known from pre-stored definitions, application server 13 may translate and store the values in the correct data format and or magnitude according to the identification.

Indeed, in one embodiment, application server 13, for example, may make use of a natural language processor (NLP) software or application in order to analyze and identify each entry line.

As shown in FIG. 6a, an entry line 61 may be provided having an attribute 23a, its value 23b and associated content 24. As the name of the attribute 23a (or the associated content information) may include the word “speed”, application server 13 may, for example, identify it as known from pre-stored attribute type definitions and expect within the following value 23b a string consisting of quantifiable numeric data followed by one of many know abbreviated magnitudes (or acronyms) associated to speed metrics. Next, application server 13 may, for example, analyze the information of the value and look for what the attribute may indicate it to be. In this example, application server 13 may, for example, identify the entry line as a numeric magnitude whereas, “30” is the numeric value and “Mph” the abbreviated magnitude. Therefore, application server 13 may store this entry line in the correct format according to the pre-stored definition. By having identified pre-stored definitions from the attribute and or associated content information, application server 13 may, for example, correct or suggest another attribute name or abbreviated magnitude in case a typographic mistake is made by the user respectively within the attribute or the value. Application server 13 may also convert the value to a different scale (e.g. “square feet” to “acre”) if necessary.

As shown in FIG. 6b, an entry line 62 may be provided having an attribute 23a, its value 23b and associated content 24. Its attribute name and content comment may be unknown to application server 13 from pre-stored definitions. Then application server 13 may read the value name and store it as a regular string value of Unicode characters.

As shown in FIG. 6c, an entry line 63 may be provided having just a value 23b and associated content 24 but without an attribute. This entry line 63 may be regarded, by application server 13, as news or overall comment on the topic by the names of the list providing it.

As shown in FIG. 6d, an entry line 64 may be provided having an attribute 23a and associated content 24. As no value to translate and store is provided, this entry line may be stored as is by application server 13.

As shown in FIG. 6e, an entry line 65 may be provided having an attribute 23a and its value 23b. In this case, no content is provided, just the comments 60a, rates 60b and timestamp 60c in the entry line 65. Application server 13 may apply the same principle as in FIG. 6a, translate and store the value in the correct format.

As shown in FIG. 6f, an entry line 66 may be provided having an attribute 23a, its value 23b and associated content 24. In this example, the attribute points to rate the overall list topic withholding the entry line. Application server 13 may, for example, identify the word “rate” from pre-stored definitions and expect within the value a score or rate from a scale or number that may result in a percentage to store. Then, application server 13 may read “5” within the value and store it as a 100% rate. In one embodiment, application server 13 may ask the user to define out of what scale to rate or suggest it (e.g. one to ten, one to five, percentage, etc.).

As shown in FIG. 6g, an entry line 67 may be provided having an attribute 23a, its value 23b and associated content 24. The attribute 23a reads the word “location” and the value 23b reads some geographical coordinates. Therefore, application server 13 may apply the same principle of FIG. 6a, translate and store the value in the correct format, as pre-stored definitions identify it as coordinates for some geographical location.

### [Method]

After analyzing and identifying 42 all entry lines 61-67 of a specification list from a user, application server 13 may, for example, link and combine 43 the received specification list with others into a collaborative specification page according to and for each of the received titles of the specification list or the analysis of its attributes and values.

### [Of List Titles]

Additionally, application server 13 may, for example, suggest the most probable collaborative specification page 21 to link to, based on recent analysis and identification of attributes 23a of the user specification list. Moreover, application server 13 may help the user correct or choose an existing title 22 for the user specification list, when its title may be new or slightly different (typographically wrong) to the existing collaborative specification pages on application server 13. Therefore, application server 13 may suggest users adding to existing collaborative specification pages thereby reducing repetitions.

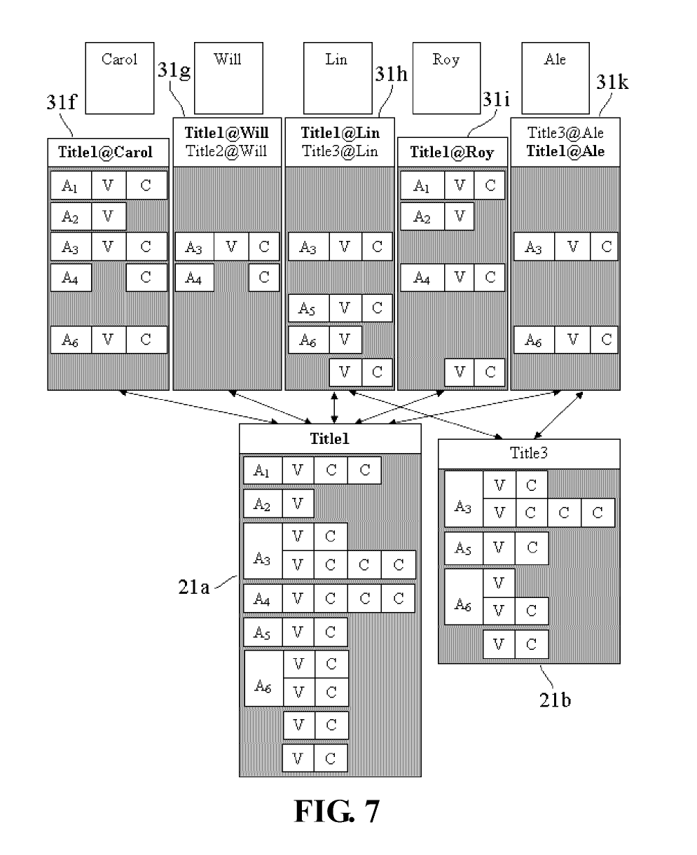

FIG. 7 illustrates an example of how user specification lists 31f-31k are built into a collaborative specification page 21 according to some embodiments of the present invention. Lists 31g, 31h, 31k may have more than one title 22, thereby indicating that the entry lines of those user specification lists may also link and combine with more than one group of lists by each title; and may be of statistical incidence to the collaborative specification pages 21a-21b by each of the titles 22 included. However, no user may have more than one list by the same title; all of the lists of a user may have at least one exclusive title 22 and may share others. For example, two users may build a specification list 31 on each of the places they live, respectively, titled “Buenos Aires” and “California”; both users may also add a second title to their specification lists “my place in the world”; these two lists will combine into respective collaborative specification pages titled “Buenos Aires” and “California”; and also will combine into a collaborative specification page titled “my place in the world” that might include the several attributes 23a that make both places appealing to them. Furthermore, when linked and combined to more lists 31, the most valuable attributes 23a and coincidences may end up describing what “my place in the world” means to collective sentiment of users (e.g. preference to live at sea level hights regardless the location). A schematic for this application example is provided in FIG. 9e.

In order to combine all entry lines 61-67 of received specification lists 31, application server 13 may, for example, label each entry line with each of the titles 22 received within it. Labels may be further used in search operations performed by users when browsing.

### [Linking Users]

Additionally, users having an account with the system and one or more user specification lists 31 linked to collaborative specification pages 21 may choose to receive updates on recent activity about those collaborative specification pages 21. Application server 13 may, for example, send e-mail and or application notification updates to their user devices 12, each time new attributes are added to the collaborative specification page; significant statistically relevant changes happen to the values of the collaborative specification page; new values emerge from other users that are of statistical relevance to the collaborative specification page; content from other users get recommendations of statistical relevance; content from their specification list improves statistical relevance within the collaborative specification page; and or any of the entry lines of any of their specification lists gets a comment or rating from another user. Furthermore, users may be able to configure this through a system website on their devices 12.

### [User Collection]

Each user having an account with the system may keep an administrative interface for them and other users to browse specification lists of their creation (their “Collection” of submited specification lists).

### [Method]

After linking and combining 43 a specification list of a user into a collaborative specification pages, application server 13 may, for example, update 44 attributes of the corresponding collaborative specification pages with statistically most relevant values for each statistically relevant identified value type, according to statistical analysis of the values of each attribute of the linked specification lists.

As detailed in example shown in FIG. 7, each specification list may provide at least one entry line consisting of at least one attribute, value or associated content and its rating. Application server 13 may, for example, combine 43 entry lines of all received specification lists (by the same title 22) and perform statistical analysis on the values of each of the matching attributes from each specification list. Next, the application server 13 may, for example, update each entry line of the collaborative specification page. Moreover, Application server 13 may, update the values for each attribute of the collaborative specification page describing the statistical results from the combined received values.

### [Adding Attributes]

Application server 13 may add new attributes from received lists to the corresponding collaborative specification pages by the titles of the received specification list. As these attribute names may be new to a collaborative specification page, their values may also be the only to it.

### [Statistically]

Whenever an attribute is not new to a collaborative specification page, application server 13 may group received values from attributes of the same name by type. Then, Application server 13 may statistically determine, according to each value type, the most resembling values for each value type group within the attribute. Moreover, attributes may include more than one statistically relevant value, for each value type, as a result of the statistical analysis. In one embodiment, these values may include their percentage of statistical weight when shown in the collaborative specification page browsed by user devices 12. Application server 13 may apply statistical analysis to the received values of each attribute, in order to determine the most resembling values, by means of any known statistical algorithm. Algorithms may vary from one value type to another. Also, several different algorithms for statistical analysis may be used in order to fulfill the task of clustering summarization, to extract the most relevant values of each certain type of data input, without departing from the principles and scope of the invention.

For example, for numerical value types, a variation of k-means algorithm (“Some methods for classification and analysis of multivariate observations”—James MacQueen, 1967) may be used in order to extract a number of mean values within each data cluster (as most resembling values) according to pre-stored parameters for the algorithm depending, for example, on: the amount of values to be clustered; a finite number of clusters; the previous most resembling values on the attribute of the collaborative specification page as the initial means for the first iteration of the algorithm. Cluster number may, for example, go from 2 to 10 as newer values of this type, relatively higher deviated from initial means are entered. The number of iterations of the algorithm to be applied may be a predefined number, for example 10, loaded by a system administrator.

Application server 13 may determine statistically most relevant values for each value type group (within each attribute) according to predetermined thresholds for deviation and statistical density. For example, in the mentioned k-means algorithm variation, a threshold for minimum relative density within maximum deviation from means may be used, for example, for determining and increasing the number of clusters. The number of clusters will determine the number of relevant values, for example, from 2 to 10. For example, having 80% of the values accumulated, within a deviation from each mean. This deviation may be, for example, 10% of the distance between the highest and the lowest means. Whenever deviation and density thresholds are passed, the need for another most relevant value increases the number of clusters used within this k-means variation. Then, application server 13 may update most relevant values of the attributes of the collaborative specification page.

### [Type Treatment]

Application server 13 may, for example, statistically determine the most relevant values, from linked specification lists, for each value type within every attribute. Application server 13 may group values of each type and perform respective statistical analysis in order to determine the most statistically relevant values within each value type. For example, application server 13 may group values of attribute “weight” for having linked values of two types: physics metrics and single string text. Within these two groups, application server 13 may perform statistical analysis to extract the most relevant values. For example: “100 lbs”, “90 lbs”, “82 lbs”, “overweight” and “underweight” with respectively 20%, 50%, 10%, 10% and 7% of statistical weight. Application server 13 may make use of value type in order to group the different values and determine each of most relevance. For example, application server 13 may group “101 lbs”, “99,5 lbs”, “100 lbs” and several other values according to a certain predetermined threshold (pre-stored within application server 13 and relative to the applied statistical calculations), as relevant value “100 lbs” with its respective statistical weight. Different value types may apply for a different statistical algorithm to extract the relevant values in order to reduce deviations, typographic mistakes and or other variations. The algorithms applied by application server 13 may vary from one type of identified value to another; and may vary for different amounts of data; and may even include other data mining and data access techniques for higher amounts of data, without departing from the principles and scope of the invention.

### [Statistical Weight]

Application server 13 may apply a certain predetermined threshold (pre-stored within application server 13), for example below 4%, to determine which values are not of relevant statistical weight and cannot be grouped within any of the relevant values. Therefore, application server 13 may group them as “Miscellaneous values” (“Misc. group”) for their corresponding attribute of the collaborative specification page.

[No attribute]

In some cases, users can input values and or content without an attribute. Application server 13 may regard these as news or comments on the whole topic discussed either on a specification list and, thereby, add to the collaborative specification page. Likewise, a comment may be used as another entry line of a specification list and may be rated by other users as well, thereby pushing its priority trough statistical weight within the corresponding linking collaborative specification page, regardless of having no attribute. In one embodiment, entry lines with no attribute may be regarded as news about a list and their value and content may be stored, respectively, as text and attached content by application server 13. Moreover, these inputs may come from sources 14.

### [Additionally Rate]

Additionally, users may browse (using their devices 12) either collaborative specification pages or specification lists of other users and rate entry lines by means of a rating scale or quantity (e.g. one to five or quantity of positive votes) and a comment describing the rating reasons. Furthermore, users may be able to mark any attributes, values and or content as harmful or deliberatively wrong alerting and activating policies thereby dynamically maintaining the accuracy of the system 10.

### [Method 35]

After updating 44 the attributes and or the values of the corresponding collaborative specification page according to statistical analysis of the linked user specification lists, application server 13 may, for example, update 45 deviation limits from each relevant value within the dynamic list (the collaborative page), according to statistical analysis and type, in order to group contents from linked specification lists to the corresponding statistically relevant values. Statistical analysis may define the cluster sizes for any identified group of a relevant value. For example, if application server 13 identified values as numeric, then the deviation limits for each value may be stored as a relative variation for each relevant value number (for example from −10% to +10%). For example, if application server 13 identified the value as a location, then deviation limits may be stored as a radius from the current most relevant position. In another example, if application server 13 identified the value as a single line text or string, then the deviation limits may be stored as allowed difference in some letters. As another example, if application server 13 identified the value as a multiline text or string, then the deviation limits may be stored, for example, in needed keywords. As with pre-stored definitions, these deviation limits, deviation limits for other value type identifications mentioned above and others may be predetermined, stored and updated within application server 13 by a system administrator.

Then, application server 13 may be enabled to load the corresponding contents for each entry line. Contents for values located only within the stored deviation limits from each relevant value (when several values are represented by a most relevant one) may be loaded, by application server 13, when a user browses contents for values of an attribute in an entry line within a collaborative specification page. Therefore, contents for any single relevant value may only include contents of values within the deviation limits from said relevant value.

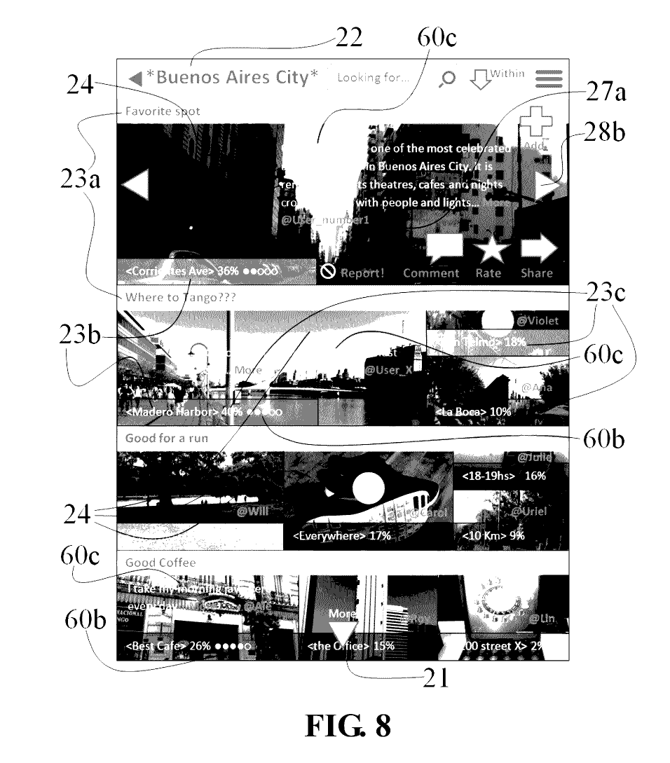

FIG. 8 illustrates an exemplary interface of a collaborative general specification page for a user to engage with according to some embodiments of the present invention. Application server 13 may, for example, provide users with the statistically most rated, browsed or active entry lines first (and set the order thereon) and let the user browse and or search through them and the rest.

### [Content Queues]

Application server 13 may, for example, set queues of content assets linked to each attribute and or value of the collaborative specification page (linked in step 43). Each queue may load the most relevant associated content for each of the attributes and or values of the collaborative specification page by using any known statistical algorithm for weighting content rating, input date and views. Application server 13 may, for example, sort each queue of contents to be shown in the collaborative specification page based on the rates of contents given by users; times contents have been rated; times the content has been browsed; date of input of said contents; acknowledgement of users who submitted the contents; and or according to attributes held within specification lists of the browsing user. For example, if the user is interested in some similar attributes within any of their lists (e.g. “Top Speed” attribute for a racing enthusiast).

Finally, application server 13 may serve the collaborative specification page to users to browse within their devices 12.

Application server 13 may, for example, load a first set of entry lines and let users browse through them. Users may request application server 13 to load the next set of entry lines in order to keep browsing more attributes and or values and or contents. Therefore, application server 13 may load the next set of entry lines with their attributes and values (in the determined statistical order) and set new queues of contents to be loaded with contents from linked user specification lists. Users may keep browsing content and requesting more entry lines and or more contents for each attribute and or value of the collaborative specification page until all are served.

### [User Search]

Additionally, users may perform search requests for attributes, values, contents and or comments throughout several collaborative specification pages and user specification lists and or within these.

### [User Rate]

Users may, for example, rate any entry line of a collaborative specification page or a user specification list, regardless of the combination of attribute, value and or content provided within, but rating only one combination for each entry line. When content is available in that combination, application server 13 may use the rating also as respective to that content.

### [Add: User Rate]

Additionally, application server 13 may give priority to contents of other users known to the user thereby showing the user contents of their acquaintances.

Users may indicate application server 13 (using their devices 12) they want to give priority to content of known other users by choosing to add the latter to a list of acquaintances within the account of the user with the system 10. Furthermore, users may indicate application server 13 (using their devices 12) they want to keep some of their contents as private from users other than their acquaintances within their account with the system 10. Users may configure their content as private or public through a system website on their devices 12.

### [Content of Users]

Application server 13 may include a link or hypertext link to the user specification list holding contents along with contents shown when browsing a collaborative specification page. This link (for example, reference 27a in FIG. 2b) may enable users of devices 12 browsing content, from a collaborative specification page, to reach other users through user specification list holding the content. For example, a picture for a certain entry line may read a reference on it “@username”, indicating the user specification list holding that picture as content.

### [Of USERNAME Titles]

In some embodiments, application server 13 may provide users holding an account with the system 10 with a personal profile. Users can fill out their profile as any other specification list, through the same input interfaces detailed above.

The title for this user specification list is that same name of the user. User names may be escaped by a special character to distinguish them from regular user specification list titles (for example “@”). Other users may collaborate on any user profile (through a collaborative specification page titled as the name of the user) providing this user has enabled this within the privacy configuration of his account. For example, a human resources office having an account with the system may upload the last performance evaluation of an employe as a user specification list titled “@employee1”. Then, if the user configured the privacy settings of his account, the collaborative specification page under the title “@employee1” may show his results to whoever is authorized (within privacy settings) without the need for user input from the employee. Moreover, if this employee has titled his personal profile with the title “Group A”, apart of the default title “@employee1”, all the attributes, values and or contents of his profile will add information into the collaborative specification page of employees in Group A (titled “Group A”). Furthermore, the results from the performance evaluation of the HR office (the user specification list titled “@employee1”), may also have a second title “Group A”, in order to build, into the collaborative specification page by that name, all the results from the employees in the group. Therefore, collaborative specification page titled “Group A” may show the collective performance of the group (from the HR office performance tests); and the statistics provided by profiles linked by the users (e.g. the average ages of the people in the group, their origin, their marital status and other). A schematic for this application example is provided in FIG. 9f.

[iframe]

Additionally, application server 13 may provide third party web pages, web feeds, blogs, social networks or other distribution platforms with specification lists (either particular lists or collaborative pages) as a simplified exemplary interface (from that of FIG. 8) to be included within, for example, as an HTML iframe. This last may be inserted as embedded code to load the linked proper user specification list or collaborative specification page within each distribution platform.

### [Of Ads and Commercial Accounts]

In one embodiment, application server 13 may, for example, provide some users with commercial accounts. Users holding commercial accounts with the system 10 may advertise within their specification lists and or those of other users and or within collaborative specification pages of their target. Furthermore, these commercial account users may also advertise by promoting the contents of the entry lines of their specification lists within the collaborative specification pages linked to them.

### [Promotion]

In one embodiment, commercial account users may promote their specification lists or their linked collaborative specification pages by sending system (or web) messages and or e-mails to other users suggesting them to rate these. These last may, for example, include, respectively, the embedded list or a link to the list within the body of the message. Indeed, application server 13 may provide commercial account users with user data that may help target promotion messages. For example, commercial users may be interested in having writers (“reviewers”) of specification lists of similar products, services or others, rate or get aware of their listed product, service or others. Moreover, commercial account users may be interested in targeting users with different interests for products, services or others, but with specific attributes within their lists. For example, a motorcycle brand may want to reach young people who live in cities and commute in bicycles by targeting users with bicycle related specification lists within their collection.

Additionally, in an embodiment, commercial account users may use device 12 locations to target some users to promote lists to for review.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

I claim:

1. A method for creating and managing dynamic collaborative statistical specification pages, the method comprising:
(a) receiving a plurality of specification lists from a plurality of users, each specification list providing at least one title and associated assets comprising at least one of an attribute, a value, a content or a combination thereof, from a plurality of communication devices;
(b) analyzing and identifying attributes, values or associated content in said lists according to pre-stored definitions to store values in a correct format;
(c) linking and combining each received specification list with others into a dynamic collaborative page according to and for each of the received titles of the specification list or the analysis of its attributes and values;
(d) updating attributes of the dynamic collaborative page with statistically most relevant values for each statistically relevant identified value type, according to statistical analysis of the values of each attribute of the linked specification lists; and
(e) updating deviation limits from relevant values within the dynamic collaborative page, according to statistical analysis and type, in order to group the corresponding contents from linked specification lists.

2. The method according to claim 1, wherein step (c) comprises linking and combining a plurality of received specification lists having the same title into said one dynamic collaborative page.

3. The method according to claim 1, wherein, in step (c), in the event that a specification list is received from a first user having a title which is not substantially the same as the title of an existing collaborative specification page or of a specification list received from a different user, comprises selecting a suggested title from the stored specification lists and returning the suggested title to the first user.

4. The method according to claim 3, wherein said suggested title is taken after searching for similar titles of existing specification lists.

5. The method according to claim 3, wherein said suggested title is taken after searching existing specification lists having matching associated assets.

6. The method according to claim 5, wherein said associated asset comprises matching attributes.

7. The method according to claim 1, wherein said received specification lists are provided through a plurality of input interfaces including: web form input of a new list; web form input of a modification or addition to a list; input by posting a message including attached media and specially designated escape characters, within the message, to define list titles, attributes, values and content comments; input by rating a list or its attributes, values or content; input through sources addressed by the user to have the necessary to build a specification list; input through application program interface functions.

8. The method according to claim 7, wherein said post comprise user generated posts on social networks.

9. The method according to claim 1, wherein each asset combination within said received specification lists further includes a timestamp, a location mark of the device at the time, a rate or a comment.

10. The method according to claim 1, wherein said values are identified based on pre-stored definitions further comprising: quantities, numbers, amounts of currencies, physics metrics, locations, colors, contact information, step number, date and time, duration, bar codes, relative rates, text names, text descriptions, frequently asked questions, list rating and other form of identity definitions, loaded by a system administrator.

11. The method according to claim 1, wherein received specification list have more than one title, further comprising linking and combining such specification lists into a different dynamic collaborative page for each title.

12. The method according to claim 1, wherein the users have an account with the system and a user account name; said account containing a personal user profile and privacy settings; said title of the specification list received from the user comprising said account name; wherein said user personal profile is updated by the user providing a specification list titled with said account name.

13. The method according to claim 1, wherein the users have an account with the system and a user account name, said account containing a personal user profile and privacy settings; said title of the specification list received from the user comprising said account name; step (c) further including linking and combining a specification list received from a first user with the profile of a second user, according to the privacy settings in the account of the second user, into a collaborative specification page titled with the account name of the second user.

14. The method according to claim 1, wherein updating attributes of the dynamic collaborative page further comprises:
(a) adding new attributes of the received lists;
(b) grouping received values from attributes of the same name by type;
(c) performing statistical analysis for each value type group within said attributes, according to value type;
(d) determining statistically most relevant values for each group type within said attributes according to predetermined thresholds for deviation and statistical weight; and
(e) assigning most relevant values to the attributes of said dynamic collaborative page.

15. The method according to claim 1, wherein updating deviation limits, from relevant values of said dynamic collaborative page, is further based on statistical analysis and on predetermined thresholds for deviation and statistical weight.

16. The method according to claim 1, wherein said statistical analysis includes a cluster algorithm.

17. The method according to claim 1, wherein step (b) includes extracting analysable information from said received content and analysing said information.

18. The method according to claim 17, wherein said information is media content information, said extracting including identifying picture objects in said graphical information.

19. The method according to claim 17, wherein said content is text or audio, said extracting including identifying words representative of objects or actions related to said title.

20. The method according to claim 1, further comprising serving and periodically updating a web site interface or embedded iframe interface and providing application program interface functions for third party applications to browse, create and manage said specification lists and dynamic collaborative pages through devices hosting a client.

21. The method according to claim 1, further comprising setting user configurations in order to receive updates, by e-mails or web messages or application program interface functions, about a dynamic collaborative page that users are linked to through said received lists from users.

22. The method according to claim 1, further comprising setting commercial account user configurations in order to promote user lists and contents or send e-mails or web messages promoting a list to certain target users linked to an indicated dynamic collaborative page or including selected titles, attributes or values within their collection of lists.

23. A computer program product comprising a non-transitory computer-readable storage medium containing computer program code for creating and managing dynamic collaborative statistical specification pages, the code executed by a processor for:
(a) receiving a plurality of specification lists from a plurality of users, each specification list providing at least one title and associated assets comprising at least one of an attribute, a value, a content or a combination thereof, from a plurality of communication devices;
(b) analyzing and identifying attributes, values or associated content in said lists according to pre-stored definitions to store values in a correct format;
(c) linking and combining each received specification list with others into a dynamic collaborative page according to and for each of the received titles of the specification list or the analysis of its attributes and values;
(d) updating attributes of the dynamic collaborative page with statistically most relevant values for each statistically relevant identified value type, according to statistical analysis of the values of each attribute of the linked specification lists; and
(e) updating deviation limits from relevant values within the dynamic collaborative page, according to statistical analysis and type, in order to group the corresponding contents from linked specification lists.

24. The computer program product of claim 23, wherein step (c) comprises linking and combining a plurality of received specification lists having the same title into said one dynamic collaborative page.

25. The computer program product of claim 23, wherein, in step (c), in the event that a specification list is received from a first user having a title which is not substantially the same as the title of an existing collaborative specification page or of a specification list received from a different user, comprises selecting a suggested title from the stored specification lists and returning the suggested title to the first user.

26. The computer program product of claim 25, wherein said suggested title is taken after searching for similar titles of existing specification lists.

27. The computer program product of claim 25, wherein said suggested title is taken after searching existing specification lists having matching associated assets.

28. The computer program product of claim 27, wherein said associated asset comprises matching attributes.

29. The computer program product of claim 23, wherein said received specification lists are provided through a plurality of input interfaces including: web form input of a new list; web form input of a modification or addition to a list; input by posting a message including attached media and specially designated escape characters, within the message, to define list titles, attributes, values and content comments; input by rating a list or its attributes, values or content; input through sources addressed by the user to have the necessary to build a specification list; input through application program interface functions.

30. The computer program product of claim 29, wherein said post comprise user generated posts on social networks.

31. The computer program product of claim 23, wherein each asset combination within said received specification lists further includes a timestamp, a location mark of the device at the time, a rate or a comment.

32. The computer program product of claim 23, wherein values are identified based on pre-stored definitions further comprising: quantities, numbers, amounts of currencies, physics metrics, locations, colors, contact information, step number, date and time, duration, bar codes, relative rates, text names, text descriptions, frequently asked questions, list rating and other form of identity definitions, loaded by a system administrator.

33. The computer program product of claim 23, wherein received specification list have more than one title, further comprising linking and combining such specification lists into a different dynamic collaborative page for each title.

34. The computer program product of claim 23, wherein the users have an account with the system and a user account name; said account containing a personal user profile and privacy settings; said title of the specification list received from the user comprising said account name; wherein said user personal profile is updated by the user providing a specification list titled with said account name.

35. The computer program product of claim 23, wherein the users have an account with the system and a user account name, said account containing a personal user profile and privacy settings; said title of the specification list received from the user comprising said account name; step (c) further including linking and combining a specification list received from a first user with the profile of a second user, according to the privacy settings in the account of the second user, into a collaborative specification page titled with the account name of the second user.

36. The computer program product of claim 23, wherein updating attributes of the dynamic collaborative page further comprises:
(a) adding new attributes of the received lists;
(b) grouping received values from attributes of the same name by type;
(c) performing statistical analysis for each value type group within said attributes, according to value type;
(d) determining statistically most relevant values for each group type within said attributes according to predetermined thresholds for deviation and statistical weight; and
(e) assigning most relevant values to the attributes of said dynamic collaborative page.

37. The computer program product of claim 23, wherein updating deviation limits, from relevant values of said dynamic collaborative page, is further based on statistical analysis and predetermined thresholds for deviation and statistical weight.

38. The computer program product of claim 23, wherein said statistical analysis includes a cluster algorithm.

39. The computer program product of claim 23, wherein step (b) includes extracting analysable information from said received content and analysing said information.

40. The computer program product of claim 23, further comprising serving and periodically updating a web site interface or embedded iframe interface and providing application program interface functions for third party applications to browse, create and manage said specification lists and dynamic collaborative pages through devices hosting a client.

41. The computer program product of claim 23, further comprising setting user configurations in order to receive updates, by e-mails or web messages or application program interface functions, about a dynamic collaborative page that users are linked to through said received lists from users.

42. The computer program product of claim 23, further comprising setting commercial account user configurations in order to promote user lists and contents or send e-mails or web messages promoting a list to certain target users linked to an indicated dynamic collaborative page or including selected titles, attributes or values within their collection of lists.

43. A system for creating and managing dynamic collaborative statistical specification pages, the system comprising: a network such as the internet, a plurality of user communication devices and an application server; connected between and to said user communication devices through said network, said system configured to:
(a) receiving a plurality of specification lists from a plurality of users, each specification list providing at least one title and associated assets comprising at least one of an attribute, a value, a content or a combination thereof, from a plurality of communication devices;
(b) analyzing and identifying attributes, values or associated content in said lists according to pre-stored definitions to store values in a correct format;
(c) linking and combining each received specification list with others into a dynamic collaborative page according to and for each of the received titles of the specification list or the analysis of its attributes and values;
(d) updating attributes of the dynamic collaborative page with statistically most relevant values for each statistically relevant identified value type, according to statistical analysis of the values of each attribute of the linked specification lists; and
(e) updating deviation limits from relevant values within the dynamic collaborative page, according to statistical analysis and type, in order to group the corresponding contents from linked specification lists.

44. The system of claim 43, wherein step (c) comprises linking and combining a plurality of received specification lists having the same title into said one dynamic collaborative page.

45. The system of claim 43, wherein said received specification lists are provided through a plurality of input interfaces including: web form input of a new list; web form input of a modification or addition to a list; input by posting a message including attached media and specially designated escape characters, within the message, to define list titles, attributes, values and content comments; input by rating a list or its attributes, values or content; input through sources addressed by the user to have the necessary to build a specification list; input through application program interface functions.

46. The system of claim 45, wherein said post comprise user generated posts on social networks.

47. The system of claim 43, wherein each asset combination within said received specification lists further includes a timestamp, a location mark of the device at the time, a rate or a comment.

48. The system of claim 43, wherein values are identified based on pre-stored definitions further comprising: quantities, numbers, amounts of currencies, physics metrics, locations, colors, contact information, step number, date and time, duration, bar codes, relative rates, text names, text descriptions, frequently asked questions, list rating and other form of identity definitions, loaded by a system administrator.

49. The system of claim 43, wherein received specification list have more than one title, further comprising linking and combining such specification lists into a different dynamic collaborative page for each title.

50. The system of claim 43, wherein the users have an account with the system and a user account name; said account containing a personal user profile and privacy settings; said title of the specification list received from the user comprising said account name; wherein said user personal profile is updated by the user providing a specification list titled with said account name.

51. The system of claim 43, wherein the users have an account with the system and a user account name, said account containing a personal user profile and privacy settings; said title of the specification list received from the user comprising said account name; step (c) further including linking and combining a specification list received from a first user with the profile of a second user, according to the privacy settings in the account of the second user, into a collaborative specification page titled with the account name of the second user.

52. The system of claim 43, wherein updating attributes of the dynamic collaborative page further comprises:
(a) adding new attributes of the received lists.
(b) grouping received values from attributes of the same name by type.
(c) performing statistical analysis for each value type group within said attributes, according to value type.
(d) determining statistically most relevant values for each group type within said attributes according to predetermined thresholds for deviation and statistical weight.
(e) assigning most relevant values to the attributes of said dynamic collaborative page.

53. The system of claim 43, wherein updating deviation limits, from relevant values of said dynamic collaborative page, is further based on statistical analysis and predetermined thresholds for deviation and statistical weight.

54. The system of claim 43, further comprising serving and periodically updating a web site interface or embedded iframe interface and providing application program interface functions for third party applications to browse, create and manage said specification lists and dynamic collaborative pages through devices hosting a client.

55. The system of claim 43, further comprising setting user configurations in order to receive updates, by e-mails or web messages or application program interface functions, about a dynamic collaborative page that users are linked to through said received lists from users.

56. The system of claim 43, further comprising setting commercial account user configurations in order to promote user lists and contents or send e-mails or web messages promoting a list to certain target users linked to an indicated dynamic collaborative page or including selected titles, attributes or values within their collection of lists.
